(19) United States
(12) Patent Application Publication
(10) Pub. No.: US 2005/0092555 A1
(43) Pub. Date: May 5, 2005

(54) Self locking elevator brake

(76) Inventor: Richard Lauch, Hopatcong, NJ (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/700,764

(22) Filed: Nov. 4, 2003

(51) Int. Cl. B66B 5/00

(52) U.S. Cl. 187/349

(57) ABSTRACT

A brake system for an elevator car wherein only authorized elevator personnel shall have access to the brake release. The system includes a self locking device for maintaining the brake system locked and therefore rendering the elevator car inoperative to passengers until authorized personnel unlock the system.

### FIELD OF THE INVENTION

The present invention relates to elevator braking systems and more particularly to a self locking assembly for elevator braking systems.

### BACKGROUND OF THE INVENTION

In certain instances, an elevator car may be caused to stop between building floors due to power failure, for example, whereupon it may be necessary to lock the elevator brake to allow the exit of any passengers. It is important that elevator brake system remain in a locked condition unavailable to release by the general public.

It has been proposed, in elevators that use a cable brake release system actuated by a handle to make the handle removable and lock the handle with a padlock, for example, to prevent the general public from releasing the brake. In such a system, the handle may be left in place allowing the car to be moved; the handle may be misplaced or lost; or the padlock misplaced during the time the elevator system was being serviced.

It is an object of the present invention to produce a brake release system for elevator systems that is accessible only by trained elevator personnel.

Another object of the invention is to produce a self locking elevator braking system including a brake handle wherein a key is needed to release the brake handle and will automatically lock the handle against movement before the elevator mechanic leaves the vicinity of the locking system.

### SUMMARY OF THE INVENTION

Other objectives and advantages of the invention may typically be achieved by a self locking elevator brake comprising: an elevator drive brake element rotatable between a brake reset position and a brake released position; a handle attached to said brake element for moving between a locked position wherein said brake element is in said brake reset position and an unlocked position wherein said brake element is in said brake released position, said handle having a latch receiving aperture formed therein; and a selectively operated locking means for maintaining said handle in said locked position, said locking means including a latching plunger releasably engaging said latch receiving aperture when said handle is in said locked position.

### BRIEF DESCRIPTION OF THE DRAWINGS

The above objects and advantages of the invention will become readily apparent to those skilled in the art from reading the following detailed description of a preferred embodiment of the invention when considered in the light of the accompanying drawings, in which:

FIG. 1 is a schematic perspective view of a portion of a self locking elevator braking system incorporating the features of the present invention;

FIG. 2 is a front elevational view of the braking system illustrated in FIG. 1;

FIG. 3 is a fragmentary side view of the handle illustrated in FIGS. 1 and 2;

FIG. 4 is a fragmentary top plan view of the latching mechanism illustrated in FIGS. 1 and 2 and an associated actuating key; and

FIG. 5 is a top plan view of the latching mechanism illustrated in FIG. 4 showing a safety switch and the handle illustrated in FIG. 3.

### DETAILED DESCRIPTION OF THE PREFERRED EMBODIMENT

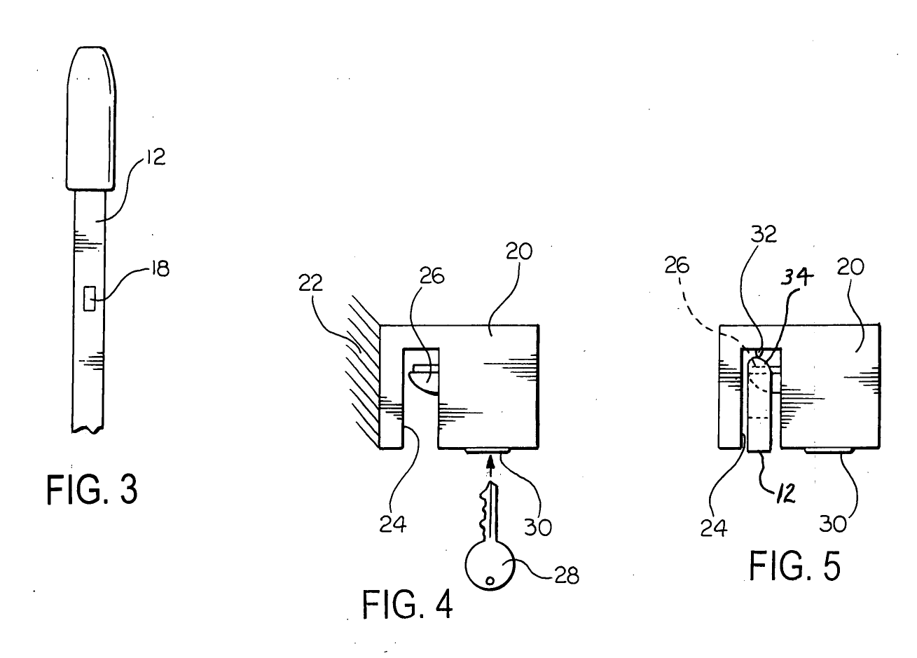

Referring to the drawings, there is illustrated a self locking elevator brake actuating element 10 including an elongate handle 12 having one end affixed to a brake element such as a drum 14 mounted to rotate about an axis 16. The drum 14 is an integral portion of the elevator car drive braking system which may be in the form of the system illustrated and described in U.S. Pat. No. 5,971,109, for example. The handle 12 is provided with a latch receiving aperture 18, as clearly shown in FIG. 3.

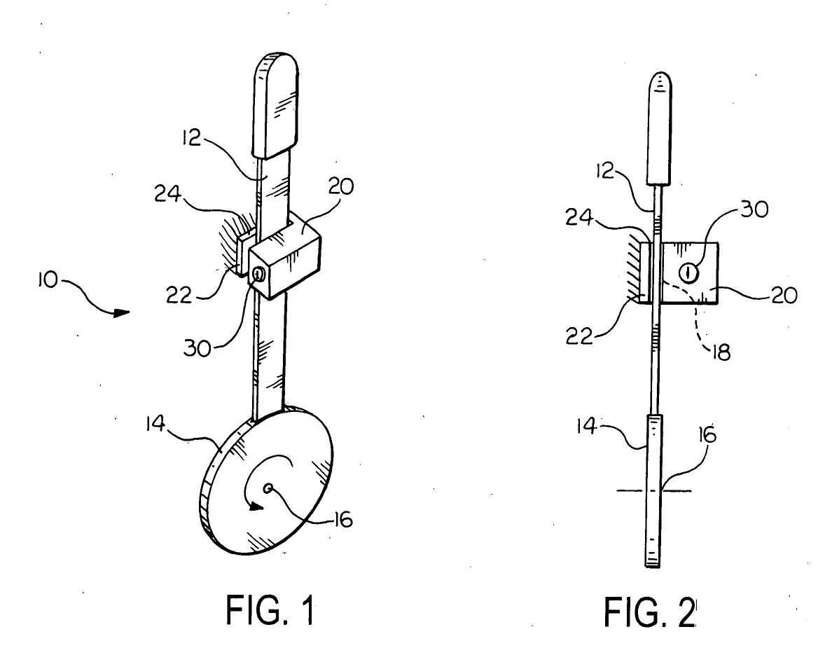

Normally, the handle 12 is in a locked position within a lock assembly 20 as illustrated in FIGS. 1 and 2. In this position of the handle 12, the drum 14 is in a reset position permitting the drive to move the elevator car as long as the drive brake (not shown) is not engaged. The lock assembly 20 includes a main housing securely mounted to a fixed surface 22, such as a cabinet or wall in the elevator control closet, for example. The lock assembly 20 includes a recess 24 for receiving a portion of the handle 12 in the region of the latch receiving aperture 18. The lock assembly 20 further includes a latching system similar in principle and structure to a standard residential or commercial door latch mechanism. In the illustrated embodiment, the latching system includes a latching plunger 26 which is normally spring biased to a closed position as clearly illustrated in FIG. 4. The latching plunger 26 is caused to be cammed inwardly toward an open position against the bias of a locking spring, not shown, by the camming action of the leading edge of the handle 12. When the outermost end of the latching plunger 26 becomes aligned with the aperture 18 of the handle 12, the latching plunger 26 is forced to its closed and locked position. The handle 12 thereupon is immobilized and locked in position and will remain in such condition until an authorized attendant inserts a key 28 into a lock cylinder 30 of the lock assembly 20 and properly unlocks the lock assembly 20 to allow the plunger 26 to be withdrawn from the locking position in the latch receiving aperture 18 of the handle 12. When the handle 12 is moved out of the recess 24, the drum 14 is rotated to a brake released position to release the drive brake and permit movement of the elevator car.

It will be appreciated that with the illustrated embodiment of the invention, a safety switch contact 32 may be mounted within the recess 24 as illustrated in FIG. 5. The safety switch contact 32 is actuated by engagement with the handle 12 in the locked position as shown in FIG. 5 to permit operation of the elevator drive. When the handle 12 is moved out of the recess 24, the safety switch contact 32 is effective to switch off the power to the elevator car drive system and will not allow the car to run other than by hand operation until the handle 12 is returned to the closed and locked position.

Further, in order to facilitate the depression of the plunger 26, a leading edge 34 of the handle 12 may be rounded or beveled to assist in camming the plunger 26 and causing the same to slide against the bias of an operating spring.

In accordance with the provisions of the patent statutes, the present invention has been described in what is considered to represent its preferred embodiment. However, it should be understood that the invention can be practiced otherwise than as specifically illustrated and described without departing from its spirit or scope.

1. A self locking elevator brake system comprising:
an elevator drive brake element rotatable between a brake reset position and a brake released position;
a handle attached to said brake element for moving between a locked position wherein said brake element is in said brake reset position and an unlocked position wherein said brake element is in said brake released position; and
a selectively operated locking means for maintaining said handle in said locked position.

2. The self locking elevator brake system as defined in claim 1 wherein said handle has a latch receiving aperture formed therein and said locking means includes a latching plunger releasably engaging said latch receiving aperture when said handle is in said locked position.

3. The self locking elevator brake system as defined in claim 1 wherein said handle includes an elongate arm having an end affixed to said brake element.

4. The self locking elevator brake system as defined in claim 3 wherein said locking means includes a latching plunger and said elongate arm includes an aperture for receiving said latching plunger.

5. The self locking elevator brake system as defined in claim 4 wherein said arm has a leading edge portion for actuating said latching plunger.

6. The self locking elevator brake system as defined in claim 5 wherein said leading edge has a rounded contour for contacting said latching plunger.

7. The self locking elevator brake system as defined in claim 1 wherein said locking means includes a key actuated lock cylinder for selectively releasing said handle from said locked position.

8. The self locking elevator brake system as defined in claim 1 wherein said locking means includes a safety switch contact actuated by engagement with said handle in said locked position.

9. A self locking elevator brake system comprising:
an elevator drive brake element rotatable between a brake reset position and a brake released position;
a handle attached to said brake element for moving between a locked position wherein said brake element is in said brake reset position and an unlocked position wherein said brake element is in said brake released position, said handle having a latch receiving aperture formed therein; and
a selectively operated locking means for maintaining said handle in said locked position, said locking means including a latching plunger releasably engaging said latch receiving aperture when said handle is in said locked position.

10. The self locking elevator brake system as defined in claim 9 wherein said handle includes an elongate arm having an end affixed to said brake element.

11. The self locking elevator brake system as defined in claim 10 wherein said arm has a leading edge portion with a rounded contour for contacting and actuating said latching plunger.

12. The self locking elevator brake system as defined in claim 9 wherein said locking means includes a key actuated lock cylinder for selectively releasing said handle from said locked position.

13. The self locking elevator brake system as defined in claim 9 wherein said locking means includes a safety switch contact actuated by engagement with said handle in said locked position.
